(19) United States
(12) Patent Application Publication
(10) Pub. No.: US 2013/0083667 A1
(43) Pub. Date: Apr. 4, 2013

(54) Accessibility Measurements

(71) Applicants: Håkan Persson, Solna (SE); Henrik Enbuske, Stockholm (SE); Andreas Olsson, Stockholm (SE); Håkan Palm, Vaxjo (SE)

(72) Inventors: Håkan Persson, Solna (SE); Henrik Enbuske, Stockholm (SE); Andreas Olsson, Stockholm (SE); Håkan Palm, Vaxjo (SE)

(73) Assignee: TELEFONAKTIEBOLAGET LM ERICSSON (PUBL), Stockholm (SE)

(21) Appl. No.: 13/518,677

(22) PCT Filed: Feb. 16, 2012
(86) PCT No.: PCT/SE12/50166

§ 371 Date: Jun. 22, 2012

Related U.S. Application Data
(60) Provisional application No. 61/542,555, filed on Oct. 3, 2011.

(51) Int. Cl. H04W 24/00

(52) U.S. Cl. 370/242

(57) ABSTRACT

Minimization of drive tests, MDT, in a radio access network, RAN, comprises determining (506), during a procedure of setting up a connection between the UE and the RAN, that an expected response from the RAN is faulty. As a consequence of determining that the expected response is faulty, at least one measurement of data relating to the faulty response is captured (508). The at least one measurement of the data relating to the faulty response is then transmitted (512) to the RAN.

### TECHNICAL FIELD

The field of the present disclosure is that of mobile communication systems and, more specifically, methods and arrangements for performing tests related to radio conditions in mobile communication systems.

### BACKGROUND

One of the important features that determine the performance of a cellular mobile communication system is the radio coverage that the system provides. Another important feature is the data throughput that the system can provide to the mobile stations operating in the system. Much work is needed to determine coverage and throughput when extending the cellular network by adding new radio base stations and when the geographic environment changes. For example, the performance of the system is often strongly affected when constructions such as large buildings, roads and railways are added to the environment in which the system is deployed.

From the point of view of an operator of a cellular mobile communication system it is therefore important, when doing for example network planning and optimization of radio operation parameters, to obtain information regarding the radio conditions at a very large number of geographic positions in the area covered by the system. This is typically done by so-called drive tests that involve having measuring equipment in vehicles and driving these vehicles around in the area of the system while performing the measurements. Needless to say, it is desirable to minimize such drive tests because they are not very efficient in terms of the number of measurements that can be made in a given time period, and also because it is a general desire to reduce the use of vehicles. These considerations are of course particularly relevant in urban areas.

The 3rd Generation Partnership Project, 3GPP, is in the process of defining solutions for enhancements of Minimizing Drive Tests, MDT. The intention of the work is documented in the technical report TR 36.805, and consists of a user equipment, UE, measurement logging function. The stage 2 description of the Release-10 functionality for MDT can be found in 3GPP Technical Specification TS 37.320.

There are no descriptions on how accessibility problems can be found within the MDT context, thus making it difficult for the operator and the network to detect accessibility problems when a UE wants to get access to the system, e.g. establish a data connection.

### SUMMARY

In order to mitigate at least some of the drawbacks as discussed above, there is provided in a first aspect a method in a user equipment, UE, for improving a process of minimization of drive tests, MDT, in a radio access network, RAN. The method comprises determining, during a procedure of setting up a connection between the UE and the RAN, that an expected response from the RAN is faulty. As a consequence of determining that the expected response is faulty, at least one measurement of data relating to the faulty response is captured. The at least one measurement of the data relating to the faulty response is then transmitted to the RAN.

In other words, an object of, and the basic concept of embodiments described herein is to improve the MDT process by defining accessibility measurements to be performed by the UE and mechanisms to transfer the measurements from UE to the network, i.e. to the RAN.

By also including measurements that are used to determine accessibility problems in the context of the MDT process, the MDT process is improved in that it becomes more complete in terms of which problems that can be detected in a mobile communication system, for example during network planning or network optimization. This makes network planning and network optimization quicker and thereby more efficient.

In a second aspect there is provided a user equipment, UE, configured for improving a MDT process in a RAN. The UE comprises processing means, memory means and communication means configured such that it is capable of determining, during a procedure of setting up a connection between the UE and the RAN, that an expected response from the RAN is faulty. The processing means, memory means and communication means are further configured such that the UE is capable of capturing, as a consequence of a determination that the expected response is faulty, at least one measurement of data relating to the faulty response. The processing means, memory means and communication means are further configured such that the UE is capable of transmitting, to the RAN as a consequence of a determination that the expected response is faulty, the at least one measurement of the data relating to the faulty response.

In a third aspect there is provided a computer program product comprising software instructions that are configured, when executed in a processing device, to perform the method of the first aspect.

The effects and advantages of the second aspect and the third aspect correspond to those summarized above in connection with the first aspect.

### BRIEF DESCRIPTION OF THE DRAWINGS

FIG. 1 schematically illustrates a cellular mobile communication system,

FIG. 2 is a schematically presented functional block diagram of a UE,

FIG. 3 is a signaling diagram of a random access channel, RACH, and radio resource control, RRC, connection setup procedure,

FIG. 4 is a flowchart of a first embodiment of a method for improving a MDT process, and

FIG. 5 is a flowchart of a second embodiment of a method for improving a MDT process.

### DETAILED DESCRIPTION

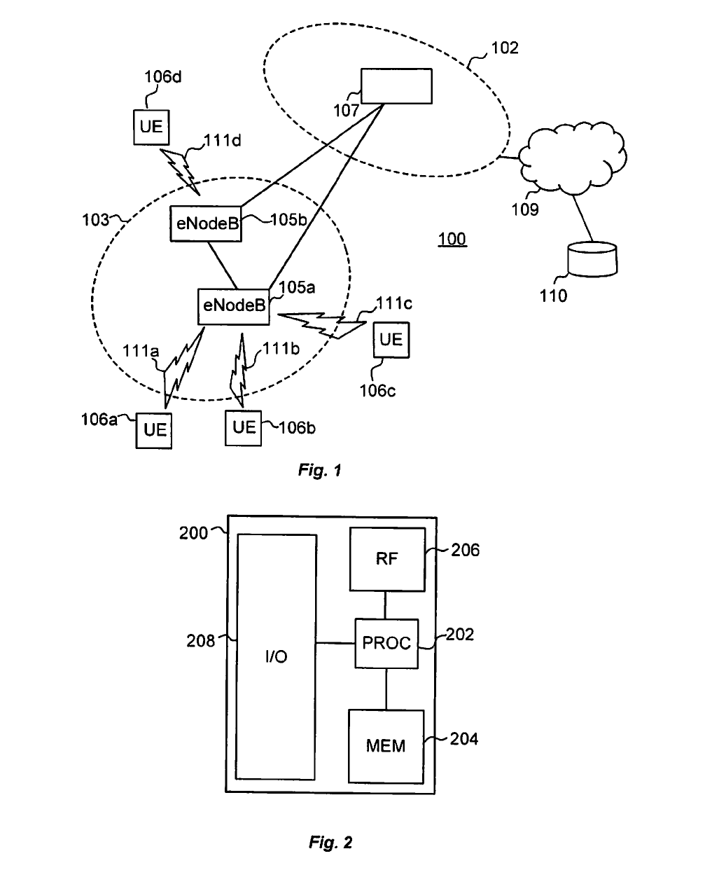

FIG. 1 illustrates schematically a cellular mobile communication system 100 in which a plurality of communication terminals 106a-d communicate via respective radio interfaces 111a-d with radio base stations 105a-b in a radio access network, RAN, 103. The system 100 in FIG. 1 is a 3GPP long term evolution, LTE, system and hence, as indicated, the communication terminals 106a-d are in the form of so-called user equipment, UE, and the radio base stations 105a-b are in the form of interconnected enhanced NodeB, eNodeB. The term UE is to be understood as representing any kind of radio connected communication terminal, device or unit etc. Similarly, the eNodeB (or eNB) is to be understood as representing any suitable radio network node, base station or communication unit that is capable of communicating with a UE via a radio interface in the RAN 103.

The RAN 103 is connected to a core network 102 in which a plurality of interacting entities are schematically represented by a single functional node 107. The core network 102 is connected to a data communication network 109 to which a data communication entity 110 is attached. The data communication entity can be a data server that provides a website on the Internet, a user terminal in the form of a personal computer etc.

The purpose of FIG. 1 is to illustrate an exemplifying environment in which a method for improving a MDT process and a corresponding UE can operate. Needless to say, a typical implementation of a system such as the system 100 in FIG. 1 comprises a large number of communicating units such as eNodeB's and UE's. Furthermore, no detailed description is necessary regarding the general operation of the entities in the system 100, the skilled person will consult the appropriate 3GPP standard documentation in order to implement the system.

FIG. 2 is a functional block diagram that schematically illustrates a UE 200 in a bit more detail than the UE's 106 in FIG. 1. The UE 200 comprises processing means, memory means and communication means in the form of a processor 202, a memory 204, radio frequency, RF, circuitry 206 and an I/O unit 208 that represents a collection of input/output units such as a display, keypad, microphone and a loud speaker that are common in typical implementations of a UE. As the skilled person will realize, the UE 200 may also be divided into processing means, memory means and communication means that have more specific functions.

The methods to be described below can be implemented in the UE 200. In such embodiments, the method actions are realized by means of software instructions that are stored in the memory 204 and are executable by the processor 202. Such software instructions can be realized and provided to the UE in any suitable way, e.g. provided via the networks 102, 103 or being installed during manufacturing, as the skilled person will realize. Moreover, as the skilled person will realize, the memory 204, the processor 202, the RF circuitry as well as the I/O unit 208 comprise software and/or firmware that, in addition to being configured such that it is capable of implementing the methods to be described, is configured to control the general operation of the UE 200 when operating in a cellular mobile communication system such as the system 100 in FIG. 1. However, for the purpose of avoiding unnecessary detail, no further description will be made in the present disclosure regarding this general operation.

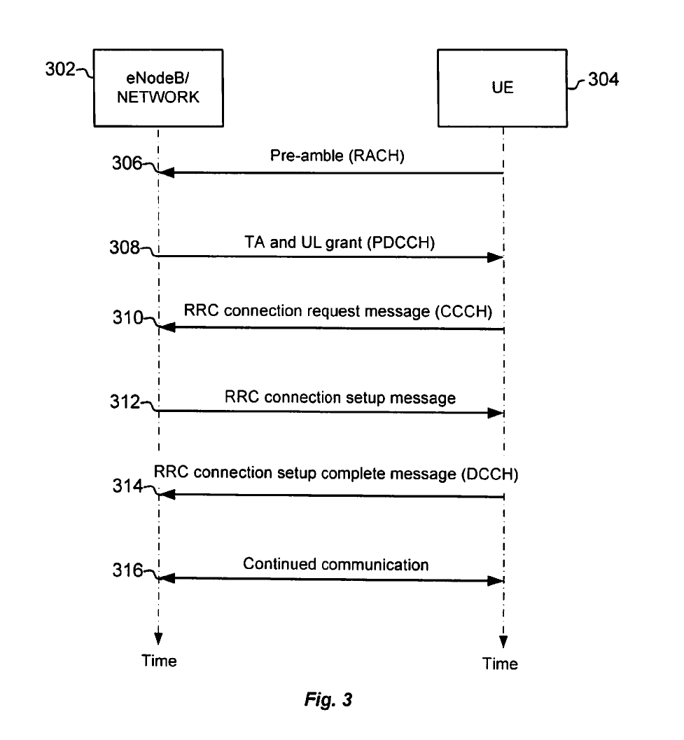

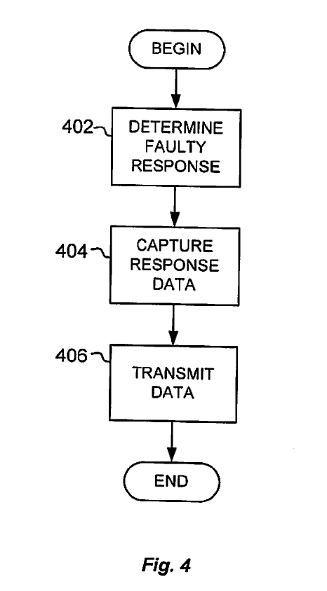

Turning now to FIGS. 3 and 4, a method for improving a MDT process will be described. The method will be described with reference to accessibility measurements that are triggered by certain radio resource control, RRC, protocol (3GPP TS 36.331 and 3GPP TS 25.331) messages/events. An event can be an outcome of reception of a message, as will be discussed in more detail below. A connection set-up procedure similar to the procedure specified in TS 36.331 includes the following signaling between an eNodeB, i.e. an eNB, in a network 302 and a UE 304. It is to be noted that the eNB is a node in a RAN and hence it is to be understood that the signaling described below takes place between the UE and a RAN.

Signal 306. UE->eNB: A pre-amble is transmitted from the UE to the eNB on the random access channel, RACH, with random access radio network temporary identity, RA-RNTI.

Typically, although not illustrated in FIG. 3, the eNB responds to the RACH preamble 306 with a random access response message.

Signal 308. eNB->UE: A timing Adjustment, TA, and uplink, UL, grant is transmitted from the eNB to the UE on the physical downlink control channel, PDCCH, for an RA-RNTI.

Signal 310. UE->eNB: A RRC Connection Request message is transmitted from the UE to the eNB on the common control channel, CCCH, the message including either temporary mobile subscriber identity, TMSI or random reference (TMSI if the UE is attached for mobility management entity, MME, selection).

Signal 312. eNB->UE: A RRC Connection Setup message is transmitted from the eNB to the UE on the CCCH for the selected UE identity in the RRC Connection Request message, such as the TMSI.

Signal 314. UE->eNB: A RRC Connection Setup Complete message is transmitted from the UE to the eNB on the dedicated control channel, DCCH.

Typically, although not illustrated in FIG. 3, the eNB may respond to the RRC Connection Setup Complete message with a response message.

If the expected responses are not noticed, this is considered as an event and captured and reported to the network. For example, if the RRC Connection Setup message 312, which is the expected response to the RRC Connection Request message 310, is not received in the UE. Such a sequence of handling expected responses is embodied in a method and is illustrated in FIG. 4.

A determination is made, in a determination action 402, that an expected response from the RAN, i.e. the eNB, is faulty. Then, as a consequence of determining that the expected response is faulty, at least one measurement of data relating to the faulty response is captured in a capturing action 404. That is, the capturing action 404 is triggered by the determination that the expected response is faulty. The at least one measurement of the data relating to the faulty response is then transmitted to the eNB, in a transmission action 406.

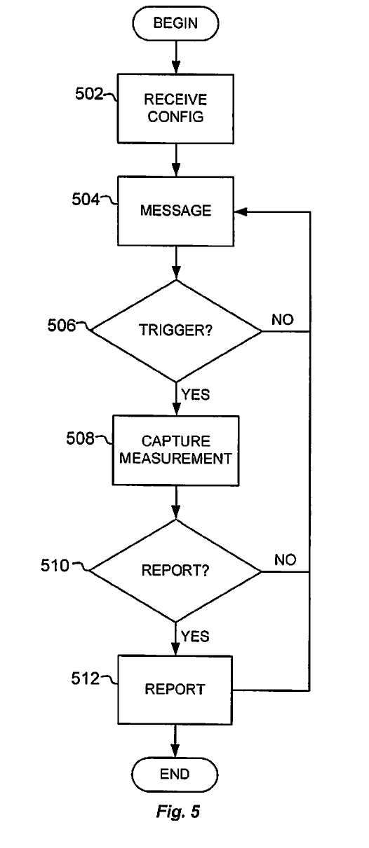

FIG. 5 illustrates another embodiment of a method in a UE for improving a MDT process. In a reception action 502, configuration parameters are received from the RAN, i.e. from an eNodeB such as the eNodeB's in FIG. 1. The configuration parameters define how the UE is to perform capturing of measurements of data relating to faulty responses from the RAN. Examples of such data relating to faulty responses are described below.

In a message action 504, transmission and reception of signalling information and messages takes place, as described above in relation to FIG. 3. These message transmissions and receptions are then checked, in a checking action 506, whether or not they involve any faulty responses. If it is found that a response to a message during the message action 504 involves a faulty response, this is considered as a trigger and measurements of data relating to the faulty response are then captured, in a capturing action 508. On the other hand, if the message responses do not involve a faulty response, transmission and reception of messages continue in the message action 504.

A check is then made, in a checking action 510, whether or not the data relating to any faulty responses is to be reported to the eNodeB. If a report is to be made, this is performed in a reporting action 512 and, if not, transmission and reception of messages continue in the message action 504. The reporting can be made by the use of a dedicated MDT reporting procedure.

An example of a triggering message transmission and reception in LTE is the reception of the RRC Connection Setup message 312 at the UE where the UE then responds with a RRC Connection Setup Complete message 314. If the Connection Setup Complete message fails to be received by the network, i.e. the RAN, this could be captured by the UE and later sent to the NW for further evaluation and possibly automatic tuning or off-line processing possibly determining if any further measures needs to be taken.

Another example of a trigger for the capturing action 508 is when no response to the random access preamble transmitted in signal 306 (FIG. 3) is received. This may be due to the fact that the random access preamble is not detected by the RAN, i.e. in the eNB, or, if the preamble is received by the RAN, no response is detected by the UE. The case may also be that the random access preamble from the UE is detected in the RAN but there are not enough resources for allowing the UE to continue with the access.

Another example of a trigger for the capturing action is when no response to the connection request message 310 is received. Another example of a trigger for the capturing action is when a connection setup message 312 received from the RAN can not be decoded.

What has been described above is that measurements of data that can be captured are the outcome and response results including related information from a random access attempt or when the RRC connection set-up message has been sent/received (i.e. collected every time an RRC Connection Request message was sent and the result was not according to expectations).

Moreover, measurements of data that can be captured can be of even more general character. For example, data relating to the faulty response can comprises an indication that no response has been received from the RAN as well as data from a (faulty) response that has been received from the RAN.

The measurements of data captured in the UE may also be combined with measured data in the eNB(s) relevant for the UE connection:
What was the use case for the Accessibility attempt:
   Non-access stratum, NAS, procedure (attach, detach, etc)
   RRC establishment cause (Mobile originating, terminating, emergency etc)
if eventually successful, number of attempts before becoming successful
include radio environment information, e.g.:
   Reference signal receive power/quality, RSRP/RSRQ, for serving cell and also neighbor cell measurements
   interference measurements for the uplink.
   Power settings used by UE at RACH attempts
Position
If available Timing Advance value
What was the UE view on the failure
International mobile subscriber identity/International mobile equipment identity (software version), IMSI/IMEISV
Which pre-amble format were used
Which preamble-IDs were used
Probability of a successful RACH attempt
Handover, HO, frequency
Tracking area update, TAU frequency
Cell update
Time spent in cell
Time spent in idle mode
Inter radio access technology handover, IRAT HO, “failure”—UE reselects to e.g. a universal terrestrial radio access, UTRA, suitable cell after unsuccessful IRAT HO.

The initiation of the UE measurement and logging could be by means of a valid configuration that is active during a logging interval/period and/or depend on event triggering, such as e.g N times an event X is triggered. In other words, a configuration message from the RAN can comprise information about which measurement of data relating to a faulty response is to be captured. Moreover, the transmission of the at least one measurement of the data relating to the faulty response can be performed as a consequence of a plurality of determinations that expected responses are faulty.

In one embodiment, the results, i.e. measurements, can be indicated to the network and then sent to the network by reusing the UE Information Procedure (UE Information Request/Response procedure) in a way already used for 3GPP Release-9 Optimized RACH, Release-10 RLF, Release-10 MDT logged measurements reporting. The measurements can be categorized in groups such that it would be possible for a UE to indicate availability for each group of measurements. One group could be “accessibility measurements” but there may also be other (sub-)divisions.

In one embodiment the collected measurements may be sent automatically at next connection set-up or during an already established connection. Also here it could be done on a per group-basis. The measurements of data can be indicated to the network and then sent to the network as described above.

In these two latter embodiments the network that receives the indication and/or information needs to be a network that is allowed to receive this information.

In summary, the present embodiments allow the network and operator to detect accessibility problems.

1-23. (canceled)

24. A method in a user equipment (UE) for improving a process of minimization of drive tests (MDT) in a radio access network (RAN) the method comprising
determining, during a procedure of setting up a connection between the UE and the RAN, that an expected response from the RAN is faulty, and as a consequence of determining that the expected response is faulty:
capturing at least one measurement of data relating to the faulty response; and
transmitting, to the RAN, the at least one measurement of the data relating to the faulty response.

25. The method of claim 24, where the determining that an expected response is faulty comprises:
transmitting, to the RAN, a random access preamble, and
detecting that no response to the random access preamble is received from the RAN.

26. The method of claim 24, where the determining that an expected response is faulty comprises:
transmitting, to the RAN, a connection request message, and
detecting that no response to the connection request message is received from the RAN.

27. The method of claim 24, where the determining that an expected response is faulty comprises:
transmitting, to the RAN, a connection request message,
receiving a connection setup message from the RAN, and
detecting that the connection setup message from the RAN cannot be decoded.

28. The method of claim 24, where the determining that an expected response is faulty comprises:
transmitting, to the RAN, a connection setup complete message, and
detecting that no response to the connection setup complete message is received from the RAN.

29. The method of claim 24, where the at least one measurement of the data relating to the faulty response comprises an indication that no response has been received from the RAN.

30. The method of claim 24, where the at least one measurement of the data relating to the faulty response comprises data from a response that has been received from the RAN.

31. The method of claim 24, where the transmission of the at least one measurement of the data relating to the faulty response to the RAN comprises a MDT measurement reporting procedure.

32. The method of claim 24, performed during a first procedure of setting up a connection between the UE and the RAN, and where the transmission of the at least one measurement of the data relating to the faulty response to the RAN comprises transmission during a subsequent procedure of setting up a connection between the UE and the RAN.

33. The method of claim 24, further comprising receiving, from the RAN, a message comprising information about which measurement of data relating to a faulty response is to be captured.

34. The method of claim 24, where the capturing of the at least one measurement of data relating to the faulty response, and the transmission of the at least one measurement of the data relating to the faulty response are performed as a consequence of a plurality of determinations that expected responses are faulty.

35. A user equipment (UE) configured for improving a process of minimization of drive tests (MDT) in a radio access network (RAN), the UE comprising processing means, memory means and communication means configured to:
determine, during a procedure of setting up a connection between the UE and the RAN, that an expected response from the RAN is faulty,
capture, as a consequence of a determination that the expected response is faulty, at least one measurement of data relating to the faulty response, and
transmit, to the RAN as a consequence of the determination that the expected response is faulty, the at least one measurement of the data relating to the faulty response.

36. The UE of claim 35, where the processing means, memory means and communication means are configured to determine that an expected response is faulty by:
transmitting, to the RAN, a random access preamble, and
detecting that no response to the random access preamble is received from the RAN.

37. The UE of claim 35, where the processing means, memory means and communication means are configured to determine that an expected response is faulty by:
transmitting, to the RAN, a connection request message, and
detecting that no response to the connection request message is received from the RAN.

38. The UE of claim 35, where the processing means, memory means and communication means are configured to determine that an expected response is faulty by:
transmitting, to the RAN, a connection request message,
receiving a connection setup message from the RAN, and
detecting that the connection setup message from the RAN cannot be decoded.

39. The UE of claim 35, where the processing means, memory means and communication means are configured to determine that an expected response is faulty by:
transmitting, to the RAN, a connection setup complete message, and
detecting that no response to the connection setup complete message is received from the RAN.

40. The UE of claim 35, where the processing means, memory means and communication means are further configured such that the at least one measurement of the data relating to the faulty response comprises an indication that no response has been received from the RAN.

41. The UE of claim 35, where the processing means, memory means and communication means are further configured such that the at least one measurement of the data relating to the faulty response comprises data from a response that has been received from the RAN.

42. The UE of claim 35, where the processing means, memory means and communication means are further configured such that the transmission of the at least one measurement of the data relating to the faulty response to the RAN comprises a MDT measurement reporting procedure.

43. The UE of claim 35, where the processing means, memory means and communication means are further configured such that a first procedure of setting up a connection between the UE and the RAN is performed, and configured such that the transmission of the at least one measurement of the data relating to the faulty response to the RAN comprises transmission during a subsequent procedure of setting up a connection between the UE and the RAN.

44. The UE of claim 35, where the processing means, memory means and communication means are further configured to:
receive, from the RAN, a message comprising information about which measurement of data relating to a faulty response is to be captured.

45. The UE of claim 35, where the processing means, memory means and communication means are further configured such that the capturing of the at least one measurement of data relating to the faulty response, and the transmission of the at least one measurement of the data relating to the faulty response are performed as a consequence of a plurality of determinations that expected responses are faulty.

46. A non-transitory computer program product comprising software instructions stored thereon, said software instructions being arranged to, when executed in a processing device, cause the processing device to:
determine, during a procedure of setting up a connection between the UE and the RAN, that an expected response from the RAN is faulty,
capture, as a consequence of a determination that the expected response is faulty, at least one measurement of data relating to the faulty response, and
transmit, to the RAN as a consequence of the determination that the expected response is faulty, the at least one measurement of the data relating to the faulty response.
